(19) United States
(12) Patent Application Publication
(10) Pub. No.: US 2013/0325570 A1
(43) Pub. Date: Dec. 5, 2013

(54) CAMPAIGN REWARD SYSTEM WITH FINANCIAL RECONSOLIDATION

(71) Applicant: ENVIZIO, INC., San Francisco, CA (US)

(72) Inventors: Youri Drozd, Fremont, CA (US); Leonid Kontsevich, San Francisco, CA (US); KR Prasad, San Francisco, CA (US); Seb Kiureghian, San Francisco, CA (US); Gary Dahl, San Francisco, CA (US)

(73) Assignee: ENVIZIO, INC., San Francisco, CA (US)

(21) Appl. No.: 13/959,929

(22) Filed: Aug. 6, 2013

Related U.S. Application Data
(63) Continuation-in-part of application No. 13/953,468, filed on Jul. 29, 2013.
Application No. 13/953,468 is a continuation-in-part of application No. 13/953,485, filed on Jul. 29, 2013.
Application No. 13/953,468 is a continuation-in-part of application No. 13/041,374, filed on Mar. 5, 2011.
Application No. 13/953,485 is a continuation-in-part of application No. 13/041,374, filed on Mar. 5, 2011.
Application No. 13/953,468 is a continuation-in-part of application No. 13/015,547, filed on Jan. 27, 2011.
Application No. 13/953,485 is a continuation-in-part of application No. 13/015,547, filed on Jan. 27, 2011.

(51) Int. Cl. G06Q 30/02

(52) U.S. Cl. CPC G06Q 30/0233
USPC 705/14.13

(57) ABSTRACT

A campaign offer system provides an offer using a mobile device. A service provider includes one or more servers with engines and attached storage. The service provider is configured to be in communication with a mobile application running on a user mobile device of a use. The service provider is in communication with an advertiser, a retailer and a financial institution. A retailer gateway is in communication with a retailer checkout system that has a unique identifier for each retailer checkout location captured by the mobile device. The unique identifier is transmitted to the service provider which effects transactions between the user and the retailer checkout system via the retailer gateway. The system prepares a report for the retailer that includes redemption data for the offers redeemed at the retailer with enough data to identify a specific redemption.

### CROSS-REFERENCE TO RELATED APPLICATIONS

This application is a continuation-in-part of U.S. Ser. No. 13/953,468 and U.S. Ser. No. 13/953,485, both filed Jul. 29, 2013, which applications are continuations-in-part of U.S. Ser. No. 13/041,374 filed Jun. 6, 2012 and 13/015,547 filed Jul. 28, 2011, which is a non-provisional of U.S. 61/697,275 filed Sep. 5, 2012, all of which applications are fully incorporated herein by reference.

### BACKGROUND

1. Field of the Invention

The present invention is directed to campaign reward systems, and more particularly to campaign reward systems that provide offers to users via their mobile devices and prepares a report for the retailer that includes redemption data for the offers redeemed at the retailer with enough data to identify a specific redemption.

2. Description of the Related Art

One of the most common concerns for many businesses is the need to develop fresh ways to acquire new customers and to retain current customers. There are currently a number of campaign offers and reward programs in place across many different merchants and products that attempt to build customer loyalty and attract new consumers. These types of programs tend to reward consumers for shopping frequently for products at the sponsoring merchant and are usually tied to the overall basket spend, rather than purchasing specific products, and certainly not for buying specific products over multiple shopping trips.

Incentive campaign reward programs, in which incentive companies contract with sponsoring companies for programs to promote sales of the sponsoring companies' products or services, are well-known. Incentive campaign reward programs include discount coupon programs; customer loyalty programs, such as frequent flyer programs, and promotional games, such as sweepstakes prizes, scratch-and-win games, and the like, in which a sponsoring company's products or services are won by successful participation in the incentive campaign reward program.

Incentive campaign reward programs offer rewards and incentives to modify behavior of individual consumers and to direct the consumers to some pre-determined action, such as the purchase of products or services upon visiting a retailer site, viewing advertising, testing a product, or the like. Companies use rewards and incentives to increase awareness of product offerings, to launch new products, to attract the attention of a newly identified audience, to differentiate products to encourage certain behavior, to obtain information, and for other purposes.

Traditional incentive campaign offers and rewards systems suffer drawbacks in terms of campaign creation, budgeting, convenience of tracking data, changing promotions, return on investment, and the like. For example, for a consumer who participates in multiple incentive programs it may take time and effort to track his or her participation in each program. For example, time is required to keep track of loyalty points earned in each separate incentive program. Therefore, when a consumer receives an offer to participate in an incentive program, the consumer may decide against participating in it, not because the incentive program is not attractive, but because the cost to the consumer, in terms of the time and effort to tracking another incentive program, exceeds the expected benefit of the incentive program. Accordingly, a consumer need has arisen for a streamlined system and method for tracking consumer participation in a variety of incentive programs from different campaign sponsors.

A similar problem exists for sponsoring companies who wish to offer campaign promotions. The collective costs of creating incentive campaign rewards programs, administering the programs, tracking the participation of consumers in the incentive campaign reward programs and fulfilling the rewards or prizes won in such incentive programs may exceed the benefits of offering the incentive campaign rewards program. These costs may be particularly high in instances where the activities associated with an incentive program must be carried out by different companies, or by different organizations within the same company. In just one small example, a clerk at a participating merchant may violate the terms of a particular campaign and allow a consumer to receive rewards on more than the campaign designated. Furthermore, the sponsor of a campaign may find itself rewarding its least economically attractive customers who are deal-driven and not likely to be brand advocates or loyalists in the future.

Existing incentive campaign offers and rewards programs do not meet the entire needs of both consumers and sponsors associated with incentive programs. One form of incentive campaign rewards program that is used extensively is that of promotional mailings. The processing of promotions, i.e., providing the appropriate check or discount coupon to the customer as a reward for the initial purchase, involves high volume and labor intensive activity, including collection, verification and organization of initial proofs of purchase and related information, preparation of the checks, coupons or other items using preprinted stock provided by the sponsor in connection with the particular promotion, and finally the sorting of individual items based on their mailing destinations.

At any given time, a typical provider of promotion services is involved with many different promotions of various sponsoring manufacturers. Preprinted forms, when provided by different sponsors, can vary in size and shape, thus creating the need to handle individual promotions separately. This increases handling expense, not only in added labor, but also in the mailing cost, as it is difficult with a single promotion to accumulate a volume of items sufficient to qualify for certain reduced postage rates, e.g. the reduced rate available for mail presorted by zip code of the destination. Manual recombination and sorting of items for multiple promotions would be prohibitively expensive.

Another form of a promotional program is coupon distribution and redemption. Many problems exist with the traditional coupon distribution and redemption system. For example, few consumers go through all the steps necessary to redeem coupons, and the consumers who do go to the trouble of redeeming coupons are disproportionately extremely price-sensitive and adept at extracting maximum value from incentive programs, often combining multiple coupons and store coupons to receive products at little to no out of pocket cost, making their redemptions a money-losing proposition for the product's manufacturer and limiting the effectiveness of the overall campaign. Additionally, many more attractive consumers forget to bring coupons that they have clipped and saved to the store, while even more disregard the coupons completely. Thus, reluctance by a “typical” consumer or a “desirable” consumer to take all necessary steps partially defeats the manufacturer's purpose for offering the purchase incentive in the first place. A manufacturer distributes coupons with the expectation that the coupons will induce sales of its product by offering a discount. However, when the coupon is forgotten or disregarded, the consumer is usually not aware of the incentive when he is selecting a product among different brands at the retailer store.

A further problem with traditional coupon redemption systems is verification. Because the verification of redemption conditions is performed by a check-out clerk using point of sale (POS) systems, sometimes the programming of the POS systems do not properly enforce a campaign's rules. As a result, campaigns are oftentimes overcharged for offers without the benefit of the required purchase.

The introduction of the digital computer and the computer network eliminates some of the inconveniences of conventional incentive campaign rewards programs, particularly those that relate to data tracking and manipulation. The digital computer is a powerful data processing tool that allows a user to organize, store and analyze data at volumes and rates that would be impossible by any prior known techniques.

Computers have been used in connection with incentive campaign rewards programs and other programs that have characteristics in common with incentive programs, but known computer incentive programs address some, but not all of the drawbacks of traditional promotions. For example, U.S. Pat. No. 5,053,955 to Peach et al. discloses an improved process of printing and assembling coupons. Peach et al. discloses a computer-based system for merging certain information for various promotions, so that a single stream of data can be used as a source for printing and mailing coupons for multiple promotions. Thus, the system of Peach et al. reduces some of the paperwork associated with single-promotion systems, but it merely mitigates, rather than solves, the problems inherent in paper-based promotions.

Computer-based promotional games are also known. Such games include scratch-and-win games, treasure hunts, video pinball and the like. Such incentive programs have advantages over paper promotions, in that data regarding participation is easily stored and manipulated. However, existing incentive campaign reward programs do not solve all consumer and sponsor needs. In particular, such promotional games do not assist consumers in tracking participation in multiple promotions and do not assist sponsors in generating incentive programs, tracking participation in incentive programs and fulfilling rewards and prizes.

Computer-based systems exist for tracking some aspects of consumer participation in incentive programs. For example, U.S. Pat. No. 5,056,019 to Schultz et al. discloses an automated purchase reward accounting system and method. In particular, Schultz et al. discloses a marketing method for providing manufacturer purchase reward offers by automatically tracking the purchases of member consumers through the use of bar-coded membership cards and using the purchase records in a data processing system to determine if the required purchases have been made to earn a reward. Each member consumer receives a reward booklet disclosing the available reward offers, a periodic status report indicating the member consumer's progress toward earning rewards, and a reward certificate for those rewards earned. The card-based system of Schultz takes advantage of certain data processing capabilities of computer systems and certain data storage capabilities of electronic card technologies; however, among other drawbacks, the system of Schultz does not address the need for a system that assists sponsor companies in generating incentive programs, in tracking participation of consumers in multiple incentive programs, or in fulfilling rewards.

The computer network offers the possibility of improved systems for offering incentive programs and for tracking participation in an incentive program. By linking together several computers and by providing shared resources and cross-platform communications, the computer network provides improved access to sophisticated applications by users at remote locations.

One of the most widely accepted and heavily used networks is the Internet. The Internet is a global system of interconnected computer networks formed into a single world-wide network. A user, through the Internet, can interactively transmit messages with users in different countries. Similarly, a user in the U.S. connected to files and libraries and other jurisdictions such as Europe and Asia can download files for personal use. Accordingly, the Internet computer network provides strong communications functions similar to the communications functions provided by ham radio operators. Moreover, the Internet computer network acts like a universal library, providing electronic access to resources and information available from Internet sites throughout the world.

Various systems and methods are known which permit a sponsor to track data of multiple parties in databases and to update information in the databases based on transactions entered into by the parties to the transactions. For example, U.S. Pat. No. 5,664,115 to Fraser discloses an interactive computer system to match buyers and sellers of real estate using the Internet. Similarly, banks, credit card companies, and other financial institutions have developed computer-based systems that track client account information and update the information upon entry of various transactions. Some such systems involve use of electronic cards and operate over computer networks. Such systems have requirements peculiar to their respective industries, and none of the existing systems address all of the problems inherent in known incentive programs, particularly the problem of the need for an incentive program system that conveniently tracks participation while offering automated generation of incentive campaign reward programs and automated fulfillment of rewards won in incentive programs.

Computer incentive campaign reward programs are offered on the Internet; however, such systems are generally offered by a single sponsor and are generally limited to offering consumers the ability to participate in incentive programs. Known campaign offers and rewards systems do not offer sponsors the ability to conveniently generate incentive programs, to track participation of consumers in multiple incentive programs, or to provide for automated fulfillment of rewards.

Another important drawback of known computer incentive campaign rewards program systems is that the obligation to fulfill the rewards promised in a promotional campaign is often a logistically difficult and expensive task. The coordination of delivering or arranging for the retrieval of the rewards for the specified winner, in volumes that permit successful incentive programs, requires coordination of prize inventory, systems and information.

There are numerous problems with current incentive campaign offers and rewards programs. The consumers who receive and redeem offers, such as coupons, may not have the purchasing characteristics to make the incentive, provided by the offer, efficient for the campaign sponsor. When an offer, i.e., coupon, is distributed to a large population, and not tied to a specific individual, the number of coupon redemptions is not known at the time of creation and distribution. There is a great deal of uncertainty in determining the redemption rate of that offer (i.e., coupon), and the associated costs to merchants or product producers, e.g. the campaigner. Current campaign rewards programs do not provide the campaigner with certainty about how much of a campaign will be redeemed. Another problem with campaign reward programs and systems is that they do not look at the state of a campaign budget and make a decision as to whether it makes sense to give a proposed recipient the offer. Yet another problem is that campaign reward programs of today do not have a cross-retailer shopper's purchaser history and the campaign sponsor offer requirements, e.g. the budget of the campaign. Still a further problem of campaign reward programs is that there is a lack of control of the offer redemption mechanism. Yet another problem with campaign offers and rewards systems is that there is no convenient way to run multiple offers concurrently and target offers and specific consumer segments.

Conventional systems and methods are inefficient, and are prone to consumer fraud, miss-redemptions, and mishandling of coupons by retailer and clearinghouse employees. The settlement usually results in account receivable record that is not cleared until weeks after the expiration date of the paper coupon.

A system implementing digital distribution, validation, redemption and clearing of promotional offers has a significant potential to reduce costs, improve manufacturers' and retailers' operational efficiencies, and provide them with instant insight into the promotional campaigns. However, despite great potential, digital promotional offers require changes to multiple IT systems of retailers and manufacturers. Many of these are a result of requirement that a process implementing promotional offers must implement measures that ensure offer validity, and uniqueness.

There is a need for an improved campaign offer system. There is a further need for a campaign offer system that enables a retailer to reconcile redeemed offers.

### SUMMARY

An object of the present invention is to provide a campaign offer system with a retailer gateway in communication with a retailer checkout system and a financial institution.

Another object of the present invention is to provide a campaign offer system that includes a service provider which invoices an advertiser for an offer with redemption information.

Yet another object of the present invention is to provide a campaign offer system with a retailer gateway in communication with a retailer checkout system and a financial institution wherein an offer is marked as invoiced after the service provider invoices the advertiser and prepares a report for the retailer that includes redemption data for the offers redeemed at the retailer with enough data to identify a specific redemption.

A further object of the present invention is to provide a campaign offer system with a retailer gateway in communication with a retailer checkout system and a financial institution, wherein in response to invoicing the advertiser the advertiser issues payment instructions to the financial institution, wherein the system in operation prepares a report for the retailer that includes redemption data for the offers redeemed at the retailer with enough data to identify a specific redemption and provide a retailer with sufficient information to conduct reconciliation of redeemed offers.

These and other objects of the present invention are achieved in a campaign offer system for providing an offer using a mobile device. A service provider includes one or more servers with engines and attached storage. The service provider is configured to be in communication with a mobile application running on a user mobile device of a use. The service provider is in communication with an advertiser, a retailer and a financial institution. A retailer gateway is in communication with a retailer checkout system that has a unique identifier for each retailer checkout location captured by the mobile device. The unique identifier is transmitted to the service provider which effects transactions between the user and the retailer checkout system via the retailer gateway. The system prepares a report for the retailer that includes redemption data for the offers redeemed at the retailer with enough data to identify a specific redemption.

### BRIEF DESCRIPTION OF THE DRAWINGS

FIG. 1 illustrates one embodiment of a system of the present invention.

FIG. 2 Illustrates a Network System with physical elements in one embodiment of the present invention.

FIG. 3 Illustrates one embodiment of the elements of the FIG. 1 system.

FIG. 4 is a flow chart illustrating an offer distribution in one embodiment of the present invention.

FIG. 5 flow chart illustrating offer issue in one embodiment of the present invention.

FIG. 6 is a flow chart illustrating one embodiment of the operation of an offer redeemer of the present invention.

FIG. 7 Illustrates one embodiment of a retailer gateway in one embodiment of the present invention.

FIG. 8 is a flowchart illustrating one embodiment of the operation of a retailer checkout system of the present invention.

FIG. 9 is a flowchart illustrating an embodiment of clearing with the present invention.

FIG. 10 illustrates one embodiment of payments for offers relative to a financial institution coupled to the advertiser and the retailer.

### DETAILED DESCRIPTION

As used herein, the term “engine” refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term “computer” is a general purpose device that can be programmed to carry out a finite set of arithmetic or logical operations. Since a sequence of operations can be readily changed, the computer can solve more than one kind of problem. A computer can include of at least one processing element, typically a central processing unit (CPU) and some form of memory. The processing element carries out arithmetic and logic operations, and a sequencing and control unit that can change the order of operations based on stored information. Peripheral devices allow information to be retrieved from an external source, and the result of operations saved and retrieved.

As used herein, the term “computer program” or just a program, is a sequence of instructions, written to perform a specified task with a computer. A computer requires programs to function, typically executing the program's instructions in a central processor. The program has an executable form that the computer can use directly to execute the instructions. The same program in its human-readable source code form, from which executable programs are derived (e.g., compiled), enables a programmer to study and develop its algorithms. A collection of computer programs and related data is referred to as the software. Source code is written in a programming language that usually follows one of two main paradigms: imperative or declarative programming. Source code may be converted into an executable file (sometimes called an executable program or a binary) by a compiler and later executed by a central processing unit. Alternatively, computer programs may be executed with the aid of an interpreter, or may be embedded directly into hardware. Computer programs can be categorized along functional lines: system software and application software. Two or more computer programs may run simultaneously on one computer from the perspective of the user, a process known as multitasking.

As used herein, the term “Internet” is a global system of interconnected computer networks that use the standard Internet protocol suite (TCP/IP) to serve billions of users worldwide. It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. The communications infrastructure of the Internet consists of its hardware components and a system of software layers that control various aspects of the architecture.

As used herein, the term “extranet” is a computer network that allows controlled access from the outside. An extranet can be an extension of an organization's intranet that is extended to users outside the organization that can be partners, vendors, and suppliers, in isolation from all other Internet users. An extranet can be an intranet mapped onto the public Internet or some other transmission system not accessible to the general public, but managed by more than one company's administrator(s). Examples of extranet-style networks include but are not limited to:
LANs or WANs belonging to multiple organizations and interconnected and accessed using remote dial-up
LANs or WANs belonging to multiple organizations and interconnected and accessed using dedicated lines
Virtual private network (VPN) that is comprised of LANs or WANs belonging to multiple organizations, and that extends usage to remote users using special “tunneling” software that creates a secure, usually encrypted network connection over public lines, sometimes via an ISP.

As used herein, the term “Intranet” is a network that is owned by a single organization that controls its security policies and network management. Examples of intranets include but are not limited to:
A LAN
A Wide-area network (WAN) that is comprised of a LAN that extends usage to remote employees with dial-up access
A WAN that is comprised of interconnected LANs using dedicated communication lines
A Virtual private network (VPN) that is comprised of a LAN or WAN that extends usage to remote employees or networks using special “tunneling” software that creates a secure, usually encrypted connection over public lines, sometimes via an Internet Service Provider (ISP).

For purposes of the present invention, the Internet, extranets and intranets collectively are referred to as (“Network Systems”).

As used herein, the term “network protocol” defines rules and conventions for communication between network devices. Protocols for computer networking all generally use packet switching techniques to send and receive messages in the form of packets. Network protocols include mechanisms for devices to identify and make connections with each other, as well as formatting rules that specify how data is packaged into messages sent and received. Some protocols also support message acknowledgement and data compression designed for reliable and/or high-performance network communication. Hundreds of different computer network protocols have been developed each designed for specific purposes and environments.

As used herein the term “wireless communication” means all procedures and forms of connecting and communicating between two or more devices using a wireless signal through wireless communication technologies and devices. Wireless communication generally works through electromagnetic signals that are broadcast by an enabled device within the air, physical environment or atmosphere. The sending device can be a sender or an intermediate device with the ability to propagate wireless signals. The communication between two devices occurs when the destination or receiving intermediate device captures these signals, creating a wireless communication bridge between the sender and receiver device. Wireless communication has various forms, technology and delivery methods including: satellite, mobile wireless network, infrared, Bluetooth and the like.

As used herein, the term “database” is used broadly to include any known or convenient means for storing data, whether centralized or distributed, relational or otherwise.

As used herein, the term “mobile device” includes but is not limited to, a cell phone, such as Apple's® iPhone®, other portable electronic devices, such as Apple's ®iPod®Touches, Apple's® iPods®, and mobile devices based on the Google ®Android® operating system, and any other portable electronic device that includes software, firmware, hardware, or a combination thereof that is capable of at least receiving the signal, decoding if needed, exchanging information with a transaction server to verify the buyer and/or seller's account information, conducting the transaction, and generating a receipt. Typical components of a mobile device may include but are not limited to persistent memories like flash ROM, random access memory like SRAM, a camera, a battery, LCD driver, a display, a cellular antenna, a speaker, a Bluetooth ®circuit, and WIFI circuitry, where the persistent memory may contain programs, applications, and/or an operating system for the mobile device.

As used herein, “Offer” is defined as containing a product(s) name, product(s) image, product(s) copy, reward value, reward limit, time period, and terms.

As used herein, “Redeem” or “Redemption” is a campaign reward that is compensation for the successful completion of the offer, either financial or non-financial remuneration.

As used herein, “Advertiser” is defined as an entity, or an agent for the entity, paying for the redemption authorizing the offers.

As used herein, “User” is defined as a consumer who purchases products or services, submits receipts, views offers, and/or receives rewards.

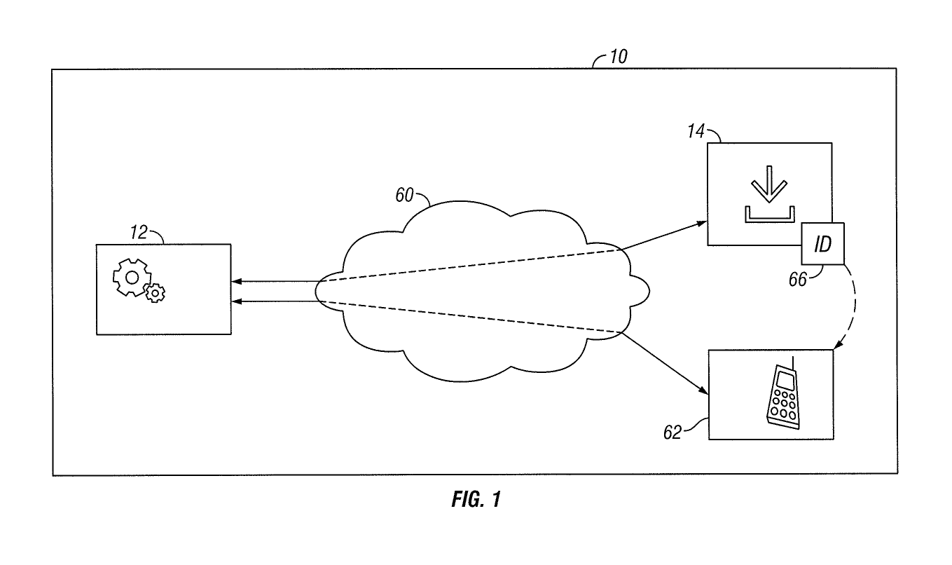

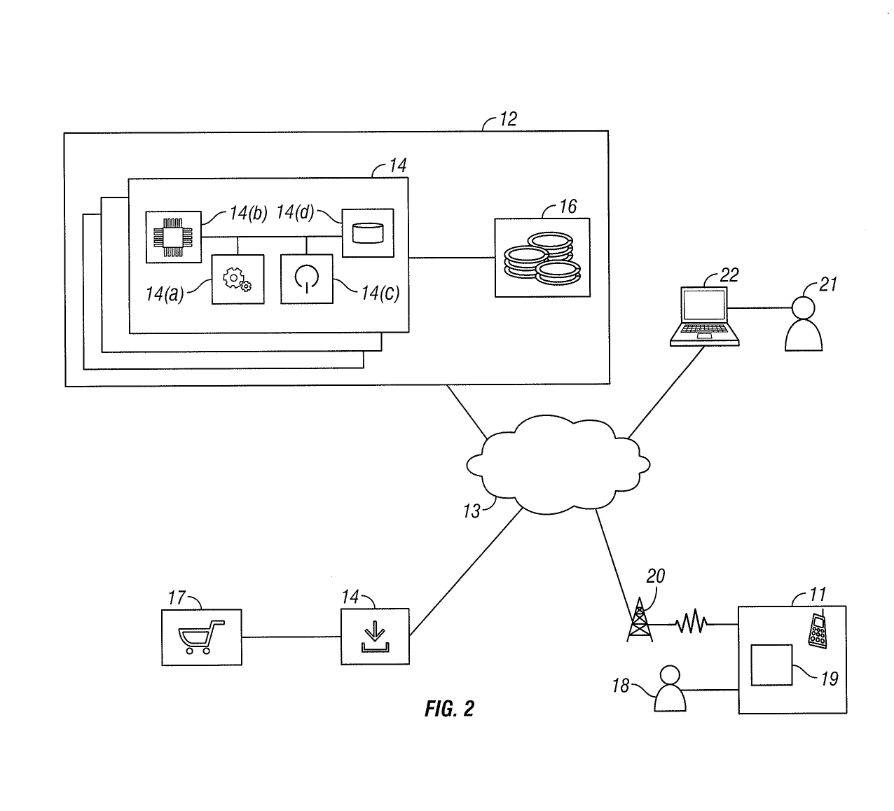

Referring to FIGS. 1 and 2, in one embodiment of the present invention, a campaign offer system 10 provides offers to users 30 via their mobile devices 62. A service provider 12 uses network systems 60 to communicate with a mobile device 62 and with a retailer gateway 38, which interfaces with retailer checkout system 64. A unique identifier 66 is assigned to each retailer checkout system 64 location and is captured by a user's mobile device 62. The unique identifier is transmitted to the service provider 12, which effects transactions between the user 30 and the retailer checkout system 64 via the retailer gateway 38. A service provider 12 has one or more servers 14 with engines and attached storage or database 16. Each of a one or more server 14 with engines includes a processor 14(a), operating memory 14(b), I/O devices 14(c) and non-volatile storage 14(d). Database 16 contains records of available offers, offer instances, e.g., offers issued to specific user 30 or users, user accounts, transaction histories, offer redemption records and the like. In one embodiment, the database 16 includes information for performing at least one of offer: (i) defining, (ii) distributing, (iii) issuing, (iv) redeeming and (v) clearing. A user 30 interacts with mobile application 70 running on his mobile device 62, which is connected through wireless network 72 and the network systems 60 to the service provider 12. An advertiser 68 interacts via a communication device 22 with service provider 12.

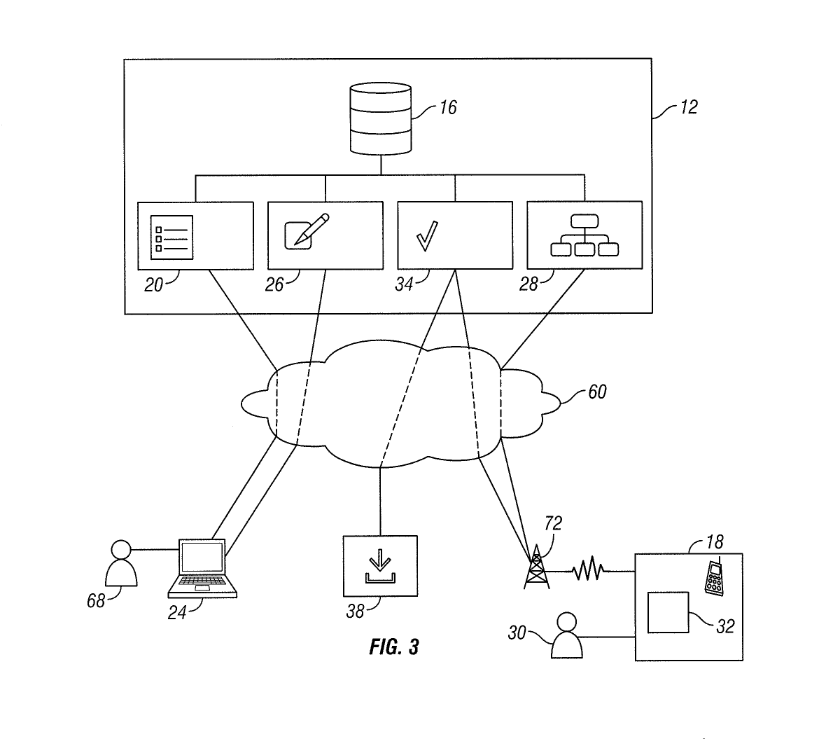

Referring now to FIG. 3 the service provider 12 includes an offer manager 20 that uses Network Systems 60 to communicate with a communication device 24. The offer manager 20 can be in communication with at least one of, a web, a desktop, a mobile application and an advertiser 68 operated offer management application. In one embodiment, the communication device 24 is a web browser. In one embodiment, the advertiser 68 uses a web application to provide the offer manager 23 with information necessary to create an offer, the offer manager 23 creating an offer by making a record in the database.

The communication device 24 can be used to communicate instructions, service requests and the like from an advertiser 68. The offer manager 20 uses these instructions, and the like, to create and modify offers by modifying records in the database 16. The records can include a product identifier. In one embodiment, the product identifier includes at least one of, a UPC code, an EAN codes and a PLU.

Acting on the service requests by a user 30 using the mobile application 32 running on the user's mobile device 18, and the offer information stored in the database 16, the offer distributor 28 sends available offers to the user 30 via the mobile application 32.

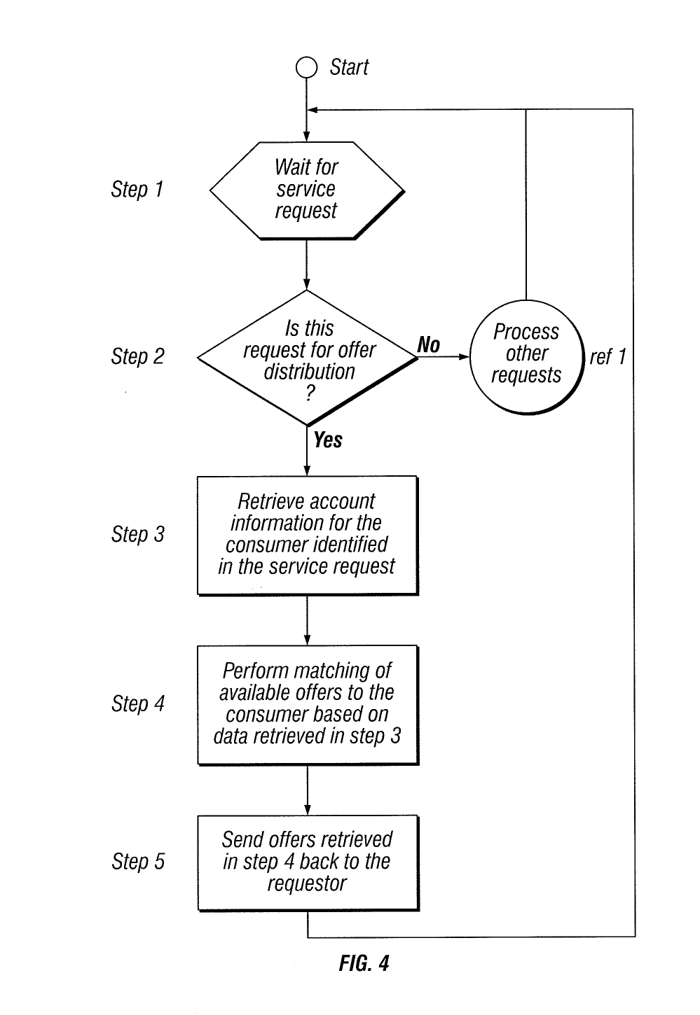

In one embodiment, the user 30, using the mobile application 32, provides offer distributor 28 details selected from at least one of, a user 30 identifier, user 30 preferences, location information, and in response the offer distributor 28 responds with the list of offers for which the user 30 is eligible, as illustrated in the offer distribution flowchart of FIG. 4.

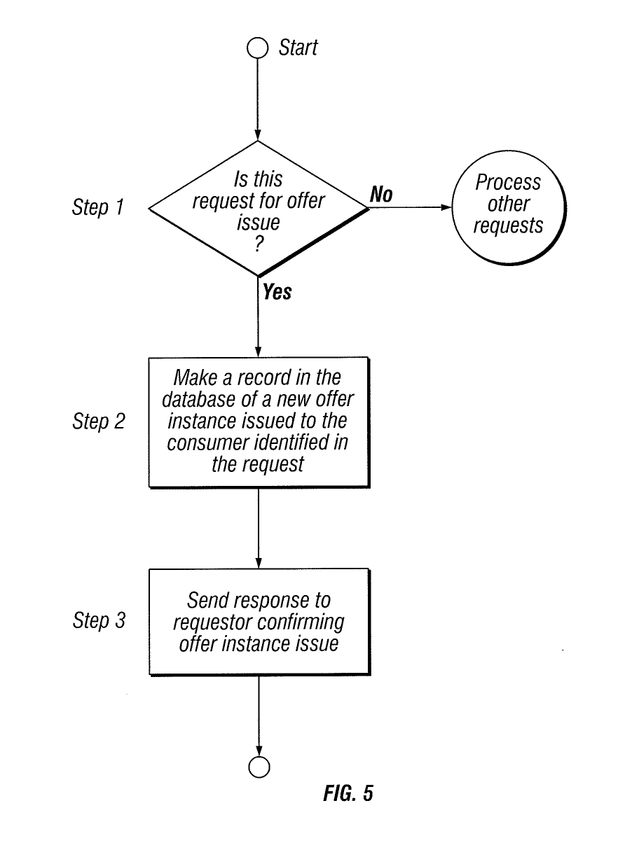

In one embodiment, the user 30 instructs the mobile application 32 to save a specific offer, which causes the mobile application 32 to communicate with the offer distributor 28. The communication with the offer distributor generates a unique offer instance and makes a record linking the offer instance with a user 30 identifier, as illustrated in the offer issue flowchart of FIG. 5, note that FIG. 5 relates to ref 1 of FIG. 4.

In one embodiment, the user 30 instructs the mobile application 32 to redeem one or more previously saved offers by acquiring a retailer checkout system location identifier (token). The mobile application 32 then communicates the token to the offer redeemer 34. The offer redeemer 34 communicates with the retailer gateway 38 that is identified by the token.

Referring back to FIG. 3, in one embodiment, the system 10 includes an offer redeemer 34 that uses the Network Systems 60 to communicate with the user's mobile application 32.

In one embodiment, the user 30 instructs the mobile application 32 to redeem one or more previously saved offers by acquiring a retailer checkout system location identifier (token). The mobile application 32 then sends the redemption service request including the token to the offer redeemer 34. The offer redeemer 34 communicates with the retailer gateway 38 that is identified by the token.

In one embodiment, the offer redeemer 34 receives service requests including current transaction information from the retailer gateway 38.

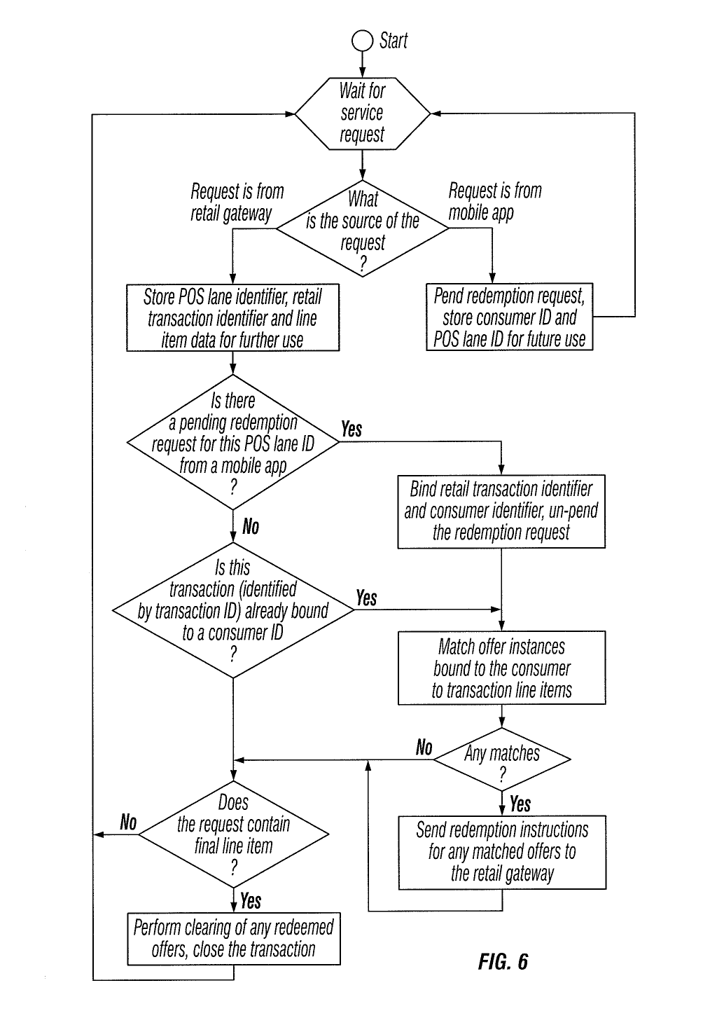

The offer redeemer 34, (i) receives current transaction information from the retailer gateway 38, (ii) receives offer redemption requests containing information identifying the user 30 and a retailer checkout system identifying information from the mobile application 32, (iii) matches offer redemption requests against current transaction data by querying the database 16, (iv) sends offer redemption data requests for matched offer instances, including but not limited to a discount amount corresponding to an offer, to the retailer gateway 38, (v) receives a complete transaction record from retailer gateway 38, and (vi) performs clearing of offer redemptions by making the record containing the information identifying redeemed offer instances and completed transaction information in the database 16, as illustrated in the offer redemption flowchart of FIG. 6. In one embodiment, the service provider 12 makes a record in the attached database 16 with sufficient transaction information to perform the clearing of the transaction. As a non-limiting example, the sufficient transaction information includes at least one of, a retailer location identifier, a specific offer identifier, timestamp, a method of offer redemption, and transaction identification information. In one embodiment, a billing subsystem 40 issues reports, invoices and payment instructions based on the offer distribution and clearing data retrieved from the attached storage 16.

Referring back to FIG. 3, the system 10 also includes a reporting subsystem 26 in communication with communication device 24 via Network Systems 60. The reporting subsystem 26 provides the advertiser 68 with reports prepared in response to the instructions entered by the advertiser 68 by querying the database 16.

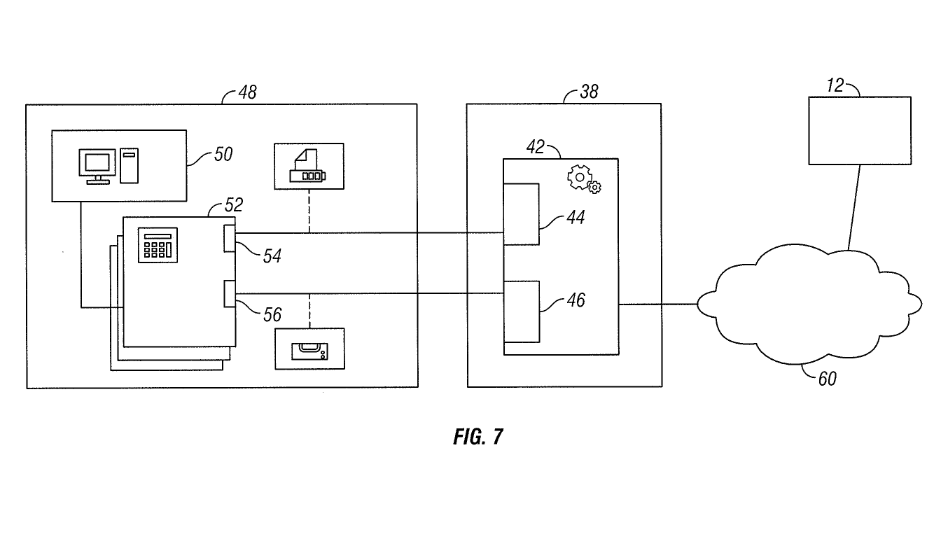

Referring to FIG. 7, in one embodiment, a retailer gateway 38 is in communication with service provider 12. The retailer gateway 38 communicates with the retailer checkout system 64 via existing retailer checkout system peripheral device communication protocols without a need to modify the communications protocols or modify a retailer checkout system software code

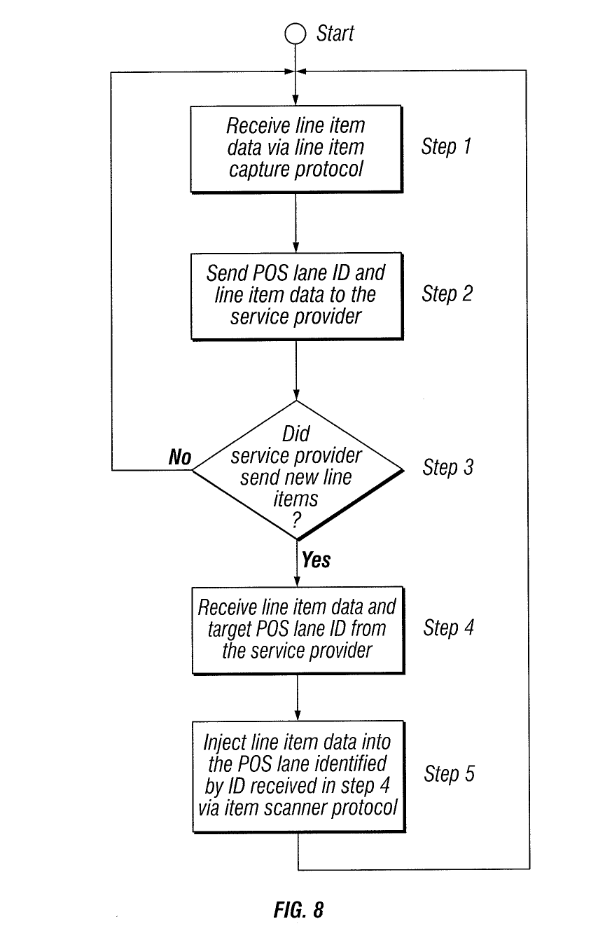

Retailer gateway 38 includes a processing unit 42 equipped with peripheral communication ports 44 emulating line item capturing protocol, including but not limited to, UPOS Fiscal Printer protocol, LAN Capture protocol, UPOS Line Item Display protocol, and the like. Processing unit 42 includes communication ports 46 emulating item scanning protocol, which as a non-limiting example can be UPOS Barcode Scanner Protocol and the like. Retailer gateway 38 communicates via Network Systems 60 to the service provider 12. FIG. 8 is a flowchart illustrating operation of the retailer checkout system 64.

Retailer gateway 38 is in communication with a retailer checkout system 64, which as a non-limiting example can be a POS system 64 containing a store controller server 50 and a plurality of POS lane registers 52, each equipped with peripheral communication ports, 54 that implement line item capturing protocol, including but not limited to, UPOS Fiscal Printer protocol, LAN Capture protocol, UPOS Line Item Display protocol, and the like. Peripheral communications ports 56 implement item scanning protocol, such as UPOS Barcode Scanner Protocol and the like.

It will be appreciated that the ports 42, 44 54 and 56 can be separate entities, different USB ports and can use the same cable, or logical ports.

In one embodiment, processing unit 42 can be a driver.

In another embodiment, processing unit 42 can be an OPOS service object, an OPOS control object, or a combination thereof.

The retailer gateway 38 emulates a plurality of retailer checkout system peripheral devices to retrieve and inject in real time line items associated with an open retailer transaction.

In one embodiment, the retailer checkout system 64 emulates a peripheral barcode scanner device to inject offer line items. In another embodiment, the retailer checkout system 64 emulates a peripheral payment terminal device to inject payment line item. In one embodiment, the retailer gateway 38 is two or more processing units 42 in communication with each other. The processing units 42 can be physical microprocessor-based devices with physical communication ports.

In another embodiment, the processing units 42 are logical devices that share processing hardware with one of the components of the retailer checkout system 64.

In one embodiment, in response to the communication of details by the retailer gateway 38, the offer redeemer 34 matches offer instances in database 16 that are associated with a user ID against transaction details. The transaction details can be basket line items, and the offer redeemer 34 passes offer instances to the retailer gateway 38. The retailer gateway 38 communicates to the retailer checkout system 64, and in response the retailer checkout system 64 reduces an amount due by an amount equal to a save value of the offers.

The retailer gateway 38 then communicates to the service provider 12 the results of a closing of a transaction. In one embodiment, the system 10 performs real time clearing of offer redemption.

The retailer checkout system 64 performs at least one of, (i) a manual entering of an item identifier, or (ii) a scanning of item identifiers for items purchased by the user 30 during a checkout. The retailer gateway 38 communicates with a retailer checkout system 64 via existing retailer checkout system 64 peripheral device communication protocols, as recited above this is achieved without a need to modify the communications protocols or modify a retailer checkout system software code. A user 30 begins a potential redemption of offers when the retailer checkout system 64 enters item identifiers of products after the user 30 enters a retailer's location identifier using the user's mobile device 62. The service provider 12 checks if there are redemption offers from the mobile device 62 that meet an advertiser's redemption rules for items in the transaction. When a redemption offer meets the advertiser's redemption rules, the retailer gateway 38 sends a redemption code to the retailer checkout system 64. The retailer gateway 38 then captures a line item relating to the redemption code that is recorded in the storage.

In one embodiment, the service provider 12 checks if there are offers presented to the user 30 of the mobile device 62. The line item can be captured by the retailer gateway 38. The retailer gateway 38 communicates the line item to a backend of the system 10.

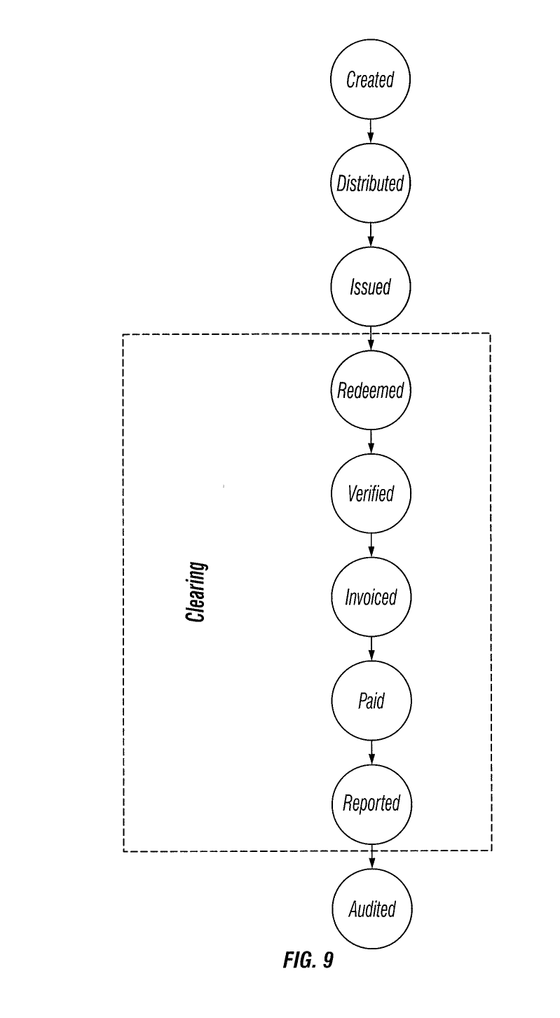

In one embodiment, clearing of offers is performed simultaneously with the checkout. FIG. 9 is a flowchart illustrating an embodiment of clearing with the present invention.

The system 10 provides that an offer of an advertiser 68 meets parameters set forth by the advertiser 68. The system 10 checks that offer issue conditions are met prior to linking an offer to a user 30. A record of the offer is made in the database. In one embodiment, the system 10 provides that offers are redeemed only in accordance with the offer redemption conditions set forth by the advertiser 68. The retailer gateway 38 passes retailer transaction information to the service provider 12. This information can include but is not limited to, sequence number, retailer checkout system 64 lane ID, cashier ID and store ID, timestamp, any line item details for the retail transaction.

Redemption offer line items are uniquely identifiable within the transaction. As non-limiting examples, uniquely identifiable can be by, redemption code, line item number in a list of ordered transaction line items, line item timestamp and a line item textual description. In one embodiment, a redemption code includes a variable field that is set by the retailer gateway 38 to a number that is generated by the gateway 38 so that the redemption code is unique within the transaction.

In one embodiment, the service provider 12 makes a record that links the transaction information received from the retailer gateway 38 with the redemption offer that is redeemed.

In one embodiment, the system 10 invoices the advertiser 68 for each redeemed offer instance within a time frame established between the advertiser 68 and the system 10. Payments relative to the offers are processed within a time frame established by the advertiser 68 and the system 10.

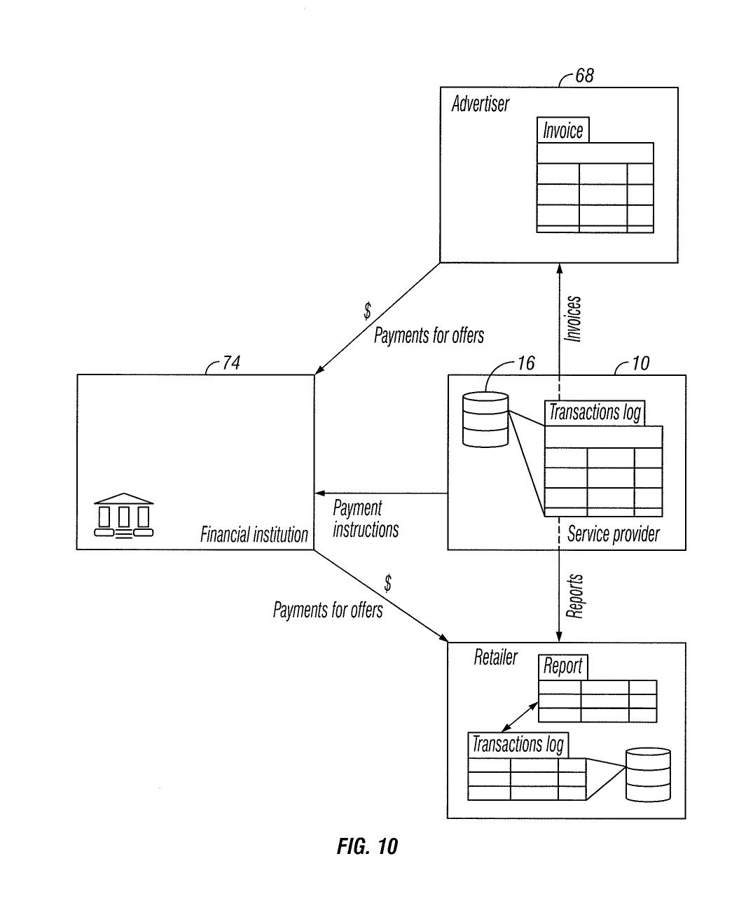

In one embodiment, payments are issued automatically by the system 10. Referring to FIG. 10, advertiser 68 and system 10 are in communication with a financial institution 74. The financial institution 74 can be the user's financial institution, a non-affiliated payment institution and the like. The financial institution can include or be associated with a variety of databases, including but not limited to product, user with user information, and transaction that can contain all types of transaction information. In one embodiment, the system 10 contacts a payment system, which may then communicate with a financial card issuing institution to either authorize or deny the transaction.

The advertiser 68 communicates the payment instructions for offers to the financial institution 74, system 10 communicates payment instruction to the financial institution 74, and the actual payments for the offers are sent from the financial institution 74 to the retailer.

In one embodiment, when the offer is issued, it is assigned a unique offer instance identifier. This instance identifier is stored in database 16. When the offer is redeemed the retailer gateway 38 captures transaction data. In one embodiment, the transaction data is sufficient data to identify the specific transaction. As a non-limiting example, the data can be one or more of, retailer store identifier (globally unique); lane number; retail transaction sequence number (unique within lane); position of redemption line item(s) within retailer transaction; redemption code; cashier ID; timestamp and the like.

The retailer gateway 38 communicates this data to the service provider 12. The service provider appends this data to a redeemed offer instance record. The offer instance is marked as redeemed. The service provider 12 invoices the advertiser 68 for the offer with redemption information. As a non-limiting example, this redemption information can include but is not limited to at least one of, location, time, amount, offer instance identifier, and the like. The offer instance is marked as invoiced. The advertiser 68 issues payment instruction to the financial institution 74 in response to the invoice step, or the service provider 12 issues payment instruction to the financial institution 74 based on the invoice step. The financial institution 74 pays the service provider 12 for the offer. The service provider 12 issues payment instructions to the financial institution 74 to pay the retailer for the offer. The offer is then marked as paid. In another embodiment, the payment need not be immediate, but can be daily, weekly, monthly and the like.

A report for the retailer is generated, including redemption data for the offer instances redeemed at the retailer, with enough data to identify specific redemption.

In one embodiment, the system 10 enables the retailer to perform financial reconciliation by providing reports that contain transaction identifying information for each offer redeemed at the retailer's checkout system 64. In one embodiment, the reports are made accessible online via one of web site, desktop application, and mobile application. The online report reflects real-time redemption information, without delays from the time of the redemption.

In one embodiment, the system 10 is configured such that an advertiser 68 can perform financial reconciliation by providing reports that contain information necessary for the reconciliation. As a non-limiting example, the information is selected from, redemption time, retailer location, amount and redemption conditions and the like.

In another embodiment, the system 10 allows for auditability by keeping records and providing the advertiser 68, the retailer and any authorized third party with an audited record.

The retailer then can identify which offer was paid for the relative payment, using the specific redemption information.

Table 1 illustrates the information used by the retailer for reconciliation.

Retailer: Best Stores Inc.

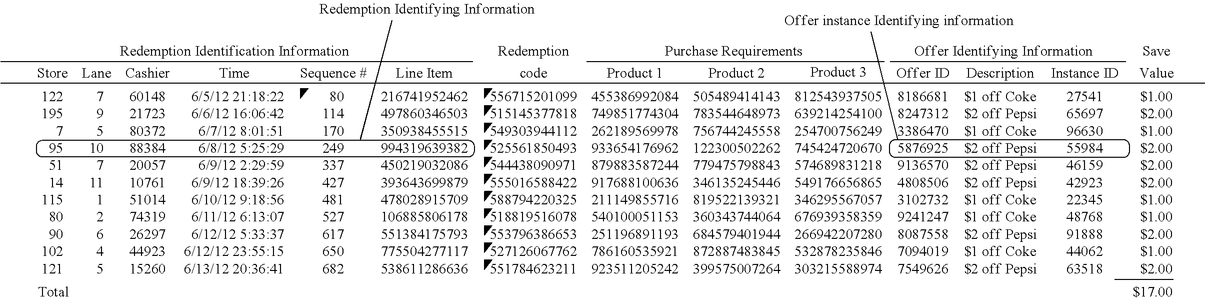

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A campaign offer system for providing an offer using a mobile device, comprising:
a service provider that includes one or more servers with engines and attached storage, the service provider configured to be in communication with a mobile application running on a user mobile device of a user, the service provider configured to be in communication with an advertiser, a retailer and a financial institution;
a retailer gateway of in communication with a retailer checkout system of a retailer that has a unique identifier for each retailer checkout location captured by the mobile device, the unique identifier being transmitted to the service provider which effects transactions between the user and the retailer checkout system via the retailer gateway; and
wherein the system in operation prepares a report for the retailer that includes redemption data for the offers redeemed at the retailer with enough data to identify a specific redemption.

2. The system of claim 1, wherein the report enables the retailer to perform financial reconciliation of redeemed offers.

3. The system of claim 1, wherein the offer is marked as invoiced after the service provider invoices the advertiser.

4. The system of claim 1, wherein in response to invoicing the advertiser the advertiser issues payment instructions to the financial institution.

5. The system of claim 1, wherein in response to invoicing the advertiser the service provider issues payment instructions to the financial institution.

6. The system of claim 1, wherein the offer is assigned a unique offer identifier when the offer is issued.

7. The system of claim 5, wherein the offer identifier is stored in a service provider database.

8. The system of claim 1, wherein when the offer is redeemed the retailer gateway captures transaction data.

9. The system of claim 7, wherein the retailer gateway communicates at least a portion of the transaction data to the service provider.

10. The system of claim 8, wherein the service provider appends the transaction data to a redeemed offer record.

11. The system of claim 1, wherein the financial institution pays the service provider for the offer.

12. The system of claim 1, wherein the service provider issues payment instructions to the financial institution to pay the retailer for the offer.

13. The system of claim 1, wherein the service provider produces a report for the retailer.

14. The system of claim 12, wherein the report includes sufficient information to identify a redemption offer.

15. The system of claim 1, wherein the retailer gateway in operation communicates with a retailer checkout system via existing retailer checkout system peripheral device communication protocols without a need to modify the communications protocols or modify a retailer checkout system software code.

16. The system of claim 2, wherein the retailer checkout system performs at least one of, (i) a manual entering of an item identifier, and (ii) a scanning of item identifiers for items purchased by the user during a checkout.

17. The system of claim 3, wherein the retailer gateway in operation communicates with the retailer checkout system via existing retailer checkout system peripheral device communication protocols without a need to modify the communications protocols or modify a retailer checkout system software code.

18. The system of claim 1, wherein the service provider checks if there are redemption offers from the mobile device that meet an advertiser's redemption rules for items in the transaction, and when a redemption offer meets the advertiser's redemption rules, the retailer gateway sends a redemption code to the retailer checkout system, with the retailer gateway capturing a line item relating to the redemption code that is recorded in the storage.

19. The system of claim 1, wherein the service provider checks if there are offers presented to the user of the mobile device.

20. The system of claim 1, wherein the line item is captured by the retailer gateway.

21. The system of claim 3, wherein the retailer gateway communicates the line item to a backend of the system.

22. The system of claim 1, wherein the clearing is performed simultaneously with the checkout.

23. The system of claim 1, wherein the system provides that an offer of an advertiser meets parameters set forth by the advertiser.

24. The system of claim 1, wherein the system checks that offer conditions are met prior to binding an offer to a user.

25. The system of claim 1, wherein a record of the offer is made in the database.

26. The system of claim 1, wherein the system provides that only one offer redemption is accepted for each of an offer.

27. The system of claim 4, wherein the retailer gateway passes retailer transaction information to the service provider.

28. The system of claim 5, wherein the information is selected from at least one of, sequence number, retailer checkout system lane ID, cashier ID and store ID.

29. The system of claim 1, wherein redemption offer line items are uniquely identifiable within the transaction.

30. The system of claim 1, wherein uniquely identifiable is by at least one of, redemption code, line item number in a list of transaction line items, line item timestamp and a line item textual description.
